(19) United States
(12) Patent Application Publication
(10) Pub. No.: US 2013/0166895 A1
(43) Pub. Date: Jun. 27, 2013

(54) ELECTRONIC DEVICE AND METHOD FOR SETTING BOOT PARAMETERS

(71) Applicants: JIN-XUAN CUI, Shenzhen City (CN); GUO-JIN LUO, Shenzhen City (CN)

(72) Inventors: JIN-XUAN CUI, Shenzhen City (CN); GUO-JIN LUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/584,774

(22) Filed: Aug. 13, 2012

(30) Foreign Application Priority Data
Dec. 27, 2011 (CN) 201110444097.1

(51) Int. Cl. G06F 9/00

(52) U.S. Cl. 713/2

(57) ABSTRACT

A method for setting boot parameters includes: controlling a display to display an input box when detecting a boot setting signal in response to user operation; receiving boot parameters input by the user from the input box; converting the boot parameters input by the user to corresponding ASCII codes, combining the ASCII codes with an identifier identifying the boot parameter to form a data segment, and storing the data segment into the CMOS RAM; reading the ASCII codes from the CMOS RAM when detecting the identifier; setting the boot parameters according to the ASCII codes, and storing the set boot parameters into the BIOS memory.

### BACKGROUND

1. Technical Field

The present disclosure relates to electronic devices and, particularly, to an electronic device and a method capable of setting boot parameters.

2. Description of Related Art

Nowadays, computers, such as, portable computers, tablet computers, and desktop computers are more and more popular. When the computer is booted, the computer starts a boot process according to boot parameters, such as boot sequence (first boot from a hard disk or a compact disk), or basic input output system (BIOS) password. The boot parameters should be set or changed in the BIOS environment, it is inconvenient for most people.

An electronic device and a method, to overcome the described limitations are thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device for setting boot parameters, in accordance with an exemplary embodiment.

FIG. 2 is schematic diagram showing an input box displayed on the electronic device of FIG. 1, in accordance with an exemplary embodiment.

FIG. 3 is flowchart illustrating a method for setting boot parameters, in accordance with an exemplary embodiment.

### DETAILED DESCRIPTION

Embodiments of the present disclosure will be described with reference to the accompanying drawings.

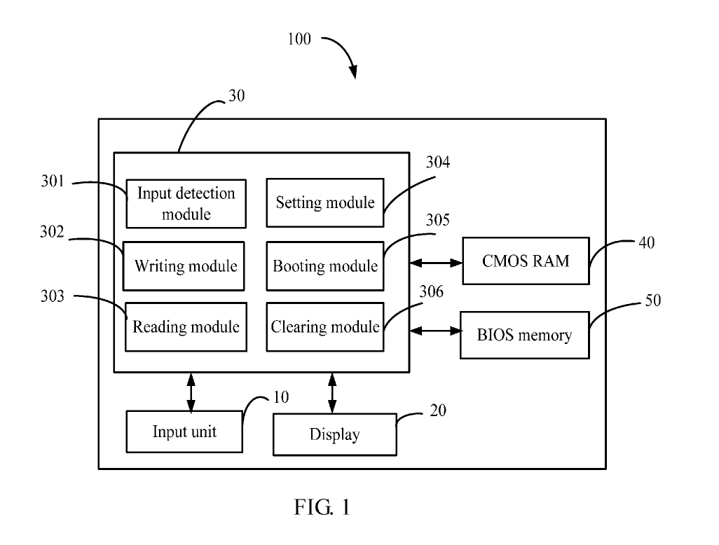

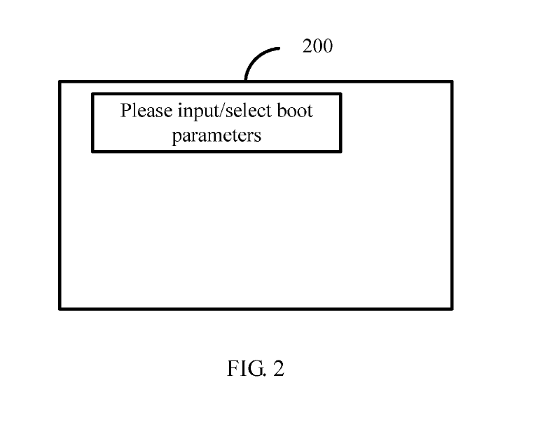

Referring to FIGS. 1 and 2, an embodiment of an electronic device 100 for setting boot parameter is illustrated. The electronic device 100 includes an input unit 10, a display 20, a processing unit 30, a complementary metal oxide semiconductor random access memory (CMOS RAM) 40, and a basic input output system (BIOS) memory 50. In the embodiment, the electronic device 100 is a computer running a windows operating system, a Linux operating system, or other operating systems. The basic input output system (BIOS) memory 50 is used to store the boot parameters, and the electronic device 100 is booted according to the boot parameters stored in the BIOS memory 50. The BIOS memory 50 can be a CMOS RAM, or a Non-Volatile Random Access Memory.

The input unit 10 can be keyboard, touch screen, and mouse, for example. The processing unit 30 includes an input detection module 301, a writing module 302, a reading module 303, and a setting module 304.

The input detection module 301 is used to detect input signals produced by the input unit 10 in response to user operations, and controls the display 20 to display an input box 200 as shown in FIG. 2, when detecting a boot setting signal. In the embodiment, the boot setting signal can be produced when a corresponding menu item is selected or a particular key is pressed by the user. In the embodiment, the input box 200 includes a prompt to prompt the user to input or select boot parameters.

The input detection module 301 is also used to receive the boot parameters input by the user from the input box 200.

The writing module 302 is used to convert the boot parameters input by the user to corresponding American standard code for information interchange (ASCII) codes, and combine the ASCII codes with an identifier to form a data segment which includes a number of bytes, and store the data segment into the CMOS RAM 40. The identifier is used to indicate the boot parameters. A first byte of the data segment is defined to store the identifier. Other bytes of the data segment are defined to store the ASCII codes, corresponding to the boot parameters input by the user. The data segment is stored in a particular position of the CMOS RAM 40, for example, such as 0F0H-0F6H.

The reading module 303 is used to detect whether the COMS RAM 40 stores the identifier and thus determines whether the CMOS RAM 40 is storing the ASCII codes when the electronic device 100 is started up and enters a BIOS environment. The reading module 303 is also used to read the ASCII codes from the CMOS RAM 40 when detecting the identifier, namely, determining that the CMOS RAM 40 stores the ASCII codes.

The setting module 304 is used to set the boot parameters according to the ASCII codes, and store the set boot parameters into the BIOS memory 50. Thus, the boot parameters can be input by the user in the operating system environment.

The electronic device 100 also includes a booting module 305 and a clearing module 306. The booting module 305 is used to boot the electronic device 100 according to the set boot parameters stored in the BIOS memory 50 when the electronic device 100 is started up. The clearing module 306 is used to clear the data segment stored in the CMOS RAM 40 after the setting module 304 has stored the set boot parameters into the BIOS memory 50.

In one embodiment, the boot parameters include a BIOS password. As described above, the input box 200 includes a prompt to prompt the user to input or select boot parameters. When the input detection module 301 receives input signals to set BIOS password input by the user from the input box 200, the writing module 302 determines whether the BIOS memory 50 has stored a BIOS password. If the writing module 302 determines the BIOS memory 50 does not store a BIOS password, the writing module 302 converts the BIOS password input by the user to corresponding ASCII codes, and combines the ASCII codes with an identifier indicating the BIOS password to obtain the data segment, and stores the ASCII codes to the CMOS RAM 40. Then the reading module 303 and the setting module 304 execute corresponding function described above to set the BIOS password.

If the writing module 302 determines the BIOS memory 50 has stored one BIOS password, the writing module 302 controls the display 20 to display a prompt to prompt the user to input an original BIOS password. The writing module 302 then determines whether the original BIOS password input by the user matches the BIOS password stored in the BIOS memory 50. If the original BIOS password input by the user matches the BIOS password stored in the BIOS memory 50, the writing module 302 controls the display 20 to display a prompt to prompt the user to input a new BIOS password, and converts the new BIOS password input by the user to corresponding ASCII codes, and combines the ASCII codes with the identifier indicating the BIOS password to obtain the data segment, and stores the ASCII codes to the CMOS RAM 40.

The reading module 303 and the setting module 304 execute corresponding functions described above to update the BIOS password. If the original BIOS password input by the user does not match the BIOS password stored in the BIOS memory 50, the writing module 302 controls the display 20 to display a prompt to prompt the user to input the original BIOS password again or locks the input box 200 for a predetermined time to forbid the user to change the BIOS password.

In the embodiment, the writing module 302 is also used to detect whether a length of the BIOS password input by the user is longer than an allowable length, and controls the display 20 to display a prompt to prompt the user that the length of the BIOS password exceeds the allowable length, if the length of the BIOS password input by the user is longer than the allowable length.

In another embodiment, the boot parameters include a boot sequence. The boot sequence defines a number of boot modes and a boot order of each boot mode. For example, the boot modes includes boot from hard disk, boot from compact disk, boot from removable device, and the boot orders of boot from hard disk, boot from compact disk, boot from removable device respectively are a first order, a second order, and a third order. Accordingly, the electronic device 100 would boot from the hard disk first, if the electronic device 100 booting from the hard disk fails, the electronic device 100 then tries to boot from the compact disk. And if the electronic device 100 booting from the compact disk fails, the electronic device 100 then tries to boot from the removable device.

The writing module 302 converts the boot sequence input by the user to a corresponding ASCII code, and combines the ASCII codes with an identifier indicating the boot sequence to obtain the data segment, and stores the data segment into the CMOS RAM 40. In the embodiment, a first byte of the data segment is defined to store the identifier, each byte of the following bytes are defined to store the ASCII code corresponding one boot mode in sequence. Such as, if the boot sequence set by the user is first boot from the hard disk and second boot from the compact disk. Then a second byte of the data segment stores the ASCII code corresponding to the boot mode of boot from the hard disk, a third byte of the data segment stores the ASCII code corresponding to the boot mode of boot from the compact disk.

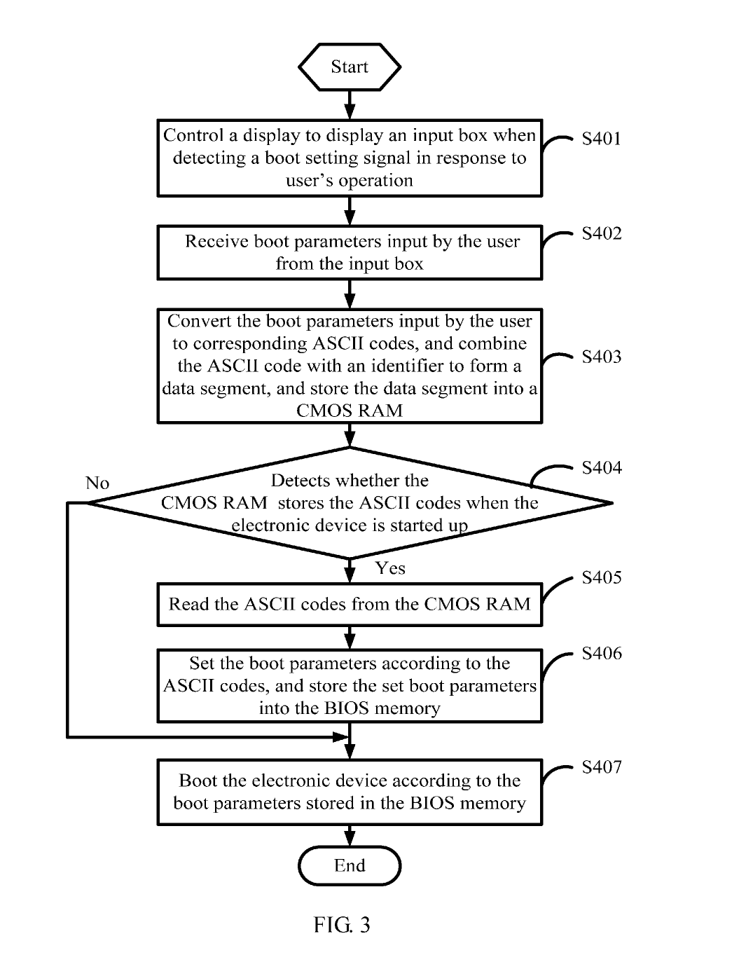

Referring to FIG. 3, a flowchart illustrating a method for setting boot parameters is shown. The method is applied in the electronic device 100 as shown in FIG. 1. In step S401, the input detection module 301 controls the display to display an input box 200 when detecting a boot setting signal in response to the user operation.

In step S402, the input detection module 301 receives the boot parameters input by the user from the input box 200.

In step S403, the writing module 302 converts the boot parameters input by the user to corresponding ASCII codes, and combines the ASCII codes with an identifier to form a data segment which includes a number of bytes, and stores the data segment into the CMOS RAM 40. The identifier is used to indicate the boot parameters. A first byte of the data segment is defined to store the identifier. Other bytes of the data segment are defined to store the ASCII codes corresponding to the boot parameters input by the user.

In step S404, the reading module 303 detects whether the COMS RAM 40 stores the identifier to determine whether the CMOS RAM 40 stores the ASCII codes.

If the reading module 303 determines that the CMOS RAM 40 does not store the ASCII codes, the process jumps to step S407, if not, in step S405, the reading module 303 reads the ASCII codes from the CMOS RAM 40.

In step S406, The setting module 304 sets the boot parameters according to the ASCII codes, and stores the set boot parameters into the BIOS memory.

In step S407, the booting module 305 boots the electronic device 100 according to the boot parameters stored in the BIOS memory 50 when the electronic device 100 is started up.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device for setting boot parameters, comprising:
an input unit, configured to produce input signals in response to user operations;
a display;
a complementary metal oxide semiconductor random access memory (CMOS RAM);
a basic input output system (BIOS) memory; and
a processing unit comprising:
an input detection module, configured to detect the input signals produced by the input unit in response to user operations, and control the display to display an input box when detecting a boot setting signal, and receive boot parameters input by the user from the input box;
a writing module, configured to convert the boot parameters input by the user to corresponding American standard code for information interchange (ASCII) codes, combine the ASCII codes with an identifier to form a data segment, and store the ASCII codes into the CMOS RAM;
a reading module, configured to detect whether the COMS RAM stores the identifier thus determines whether the CMOS RAM stores the ASCII codes when the electronic device is started up, and read the ASCII codes from the CMOS RAM when determining that the CMOS RAM stores the ASCII codes; and
a setting module, configured to set the boot parameters according to the ASCII codes, and store the set boot parameters into the BIOS memory.

2. The electronic device according to claim 1, further comprising a booting module, wherein the booting module is configured to boot the electronic device according to the set boot parameters stored in the BIOS memory when the electronic device is started up.

3. The electronic device according to claim 1, wherein the data segment comprises a number of bytes, the identifier is configured to indicate the boot parameters, a first byte of the data segment is defined to store the identifier, other bytes of the data segment are defined to store the ASCII codes correspond to the boot parameters input by the user.

4. The electronic device according to claim 1, further comprising a clearing module, wherein the clearing module is configured to clear the data segment stored in the CMOS RAM after the setting module has stored the set boot parameters into the BIOS memory.

5. The electronic device according to claim 1, wherein the boot parameters input by the user comprises a BIOS password, the writing module is further configured to determine whether the BIOS memory has stored one BIOS password when the input detection module receives input signals to set BIOS password from the input box; and is further configured to convert the BIOS password input by the user to corresponding ASCII codes, and combine the ASCII codes with an identifier indicating the BIOS password to obtain the data segment, and store the data segment to the CMOS RAM, when determining the BIOS memory does not store any BIOS password.

6. The electronic device according to claim 5, wherein the writing module is further configured to control the display 20 to display a first prompt to prompt the user to input an original BIOS password if the writing module determines the BIOS memory has stored one BIOS password, the writing module is further configured to determine whether the original BIOS password input by the user matches the BIOS password stored in the BIOS memory, and control the display to display a second prompt to prompt the user to input a new BIOS password, if the original BIOS password input by the user matches the BIOS password stored in the BIOS memory, and is further configured to convert the new BIOS password input by the user to corresponding ASCII codes, and combine the ASCII codes with the identifier indicating the BIOS password to obtain the data segment, and store the data segment to the CMOS RAM.

7. The electronic device according to claim 6, wherein the data segment comprises a number of bytes, a first byte of the segment stores the identifier to identify the BIOS password, and the other bytes stores the ASCII codes corresponding to the BIOS password.

8. The electronic device according to claim 6, wherein the writing module is further configured to detect whether a length of the BIOS password input by the user is longer than an allowable length, and control the display to display a third prompt to prompt the user that the length of the BIOS password exceeds the allowable length.

9. The electronic device according to claim 1, wherein the boot parameters comprises a boot sequence, the boot sequence defines a number of boot modes and a boot order of each boot, the writing module is further configured to convert the boot sequence input by the user to the corresponding ASCII codes, and combine the ASCII codes with an identifier indicating the boot sequence to obtain the data segment, and store the data segment to the CMOS RAM.

10. The electronic device according to claim 9, wherein a first byte of the data segment comprises the identifier, each byte of the following bytes comprises the ASCII code corresponding one boot mode in sequence.

11. A method for setting boot parameters of an electronic device, the electronic device comprises:
an input unit;
a display;
a complementary metal oxide semiconductor random access memory (CMOS RAM); and
a basic input output system (BIOS) memory
the method comprising:
controlling the display to display an input box when detecting a boot setting signal in response to user operation on the input unit;
receiving boot parameters input by the user from the input box;
converting the boot parameters input by the user to corresponding ASCII codes, combining the ASCII codes with an identifier identifying the boot parameter to form a data segment, and storing the data segment into the CMOS RAM;
detecting whether the COMS RAM stores the identifier thus determines whether the CMOS RAM stores the ASCII codes when the electronic device is started up;
reading the ASCII codes from the CMOS RAM when determining the CMOS RAM stores the ASCII codes;
setting the boot parameters according to the ASCII codes, and storing the set boot parameters into the BIOS memory.

12. The method according to claim 11, further comprising:
booting the electronic device according to the set boot parameters stored in the BIOS memory when the electronic device is started up.

13. The method according to claim 11, further comprising:
clearing the data segment stored in the CMOS RAM after the setting module has stored the set boot parameters into the BIOS memory.
